(19) United States
(12) Patent Application Publication
(10) Pub. No.: US 2010/0001837 A1
(43) Pub. Date: Jan. 7, 2010

(54) ATTACHABLE RFID DEVICES AND METHODS FOR IDENTIFYING OBJECTS

(75) Inventors: Tony Mazzella, Cleveland, OH (US); Mark Daliberti, Cleveland, OH (US); Rich Brett, Cleveland, OH (US)

Correspondence Address: Emerson, Thomson & Bennett, LLC, 777 W. Market Street, Akron, OH, 44303, US

(73) Assignee: Mazzella Lifting Technologies, Cleveland, OH (US)

(21) Appl. No.: 12/168,473

(22) Filed: Jul. 7, 2008

(51) Int. Cl. H04Q 5/22

(52) U.S. Cl. 340/10.1

(57) ABSTRACT

The present invention generally relates to devices and methods for identifying objects, especially those which are subject to inspection regimes. Some embodiments comprise a housing that can be attached to an object. Some embodiments also include an RFID tag contained within a housing. Such RFID tags may be adapted to contain object-identifying information. Some embodiments optionally include a means for color coding the housing.

### I. BACKGROUND OF THE INVENTION

A. Field of Invention

This invention generally relates to attachable devices and methods for identifying objects using RFID technologies.

B. Description of the Related Art

It is known to use cable, such as braided metal cables, for lifting heavy objects in an industrial setting. Government regulations and industry standards require lifting and rigging hardware, devices and equipment to be regularly inspected and maintained. Accordingly, cable manufacturers permanently attach thick metal identification tags with stamped identification data. Such tags must be read visually by a human inspector, which can be time consuming. This is especially problematic in settings where numerous cables are in use at once. Furthermore, identification tags alone do not convey information such as inspection dates.

Attempts have been made to add inspection data using secondary identifying structures that attach to the original metal ID. For example, identifying structures have been made by looping a cable through the existing ID tag and permanently anchoring the ends together, for instance with a crimping clip. In some cases, the secondary identifying structure bares a bar code, which includes all of the information from the original tag. The bar code can be scanned with a handheld scanner, thereby identifying the cable. However, the bar codes are easily damaged and rendered unreadable in the harsh environments in which such cables are used. Therefore, the barcodes need to be replaced frequently. Furthermore, the bar code does not address the need to quickly determine whether the cable is due for inspection.

Attempts have also been made to quickly determine whether a particular cable is due for inspection. One prior method involves attaching a color coded tag to the original metal ID tag. For example, orange may represent all cables inspected in January 2008. When the cables are next inspected, the orange tags are cut off and a tag baring a new color such as yellow is attached. Therefore, the inspector only needs to look for orange tags to determine whether a particular cable is due for inspection. However, this method involves a substantial amount of waste because tags are used for a short time and then must be replaced.

Thus, there is a need in the art to rapidly determine whether a cable is due for inspection and identify the cable. Furthermore there is a need in the art to do so in a way that limits waste.

### II. SUMMARY OF THE INVENTION

Some embodiments relate to an object identification device, comprising: a housing having at least one outer surface and at least one inner surface spaced apart from the outer surface and defining a thickness, the inner surface enclosing a space adapted to receive one or more components; at least one RFID tag; a loopable member having two ends spaced apart and defining a generally elongate shape; and at least one anchor member for anchoring the ends of one or more ends of the loopable member in a fixed configuration relative to the housing.

Other embodiments relate to a method for inspecting objects comprising the steps of: attaching the object identification device of claim 1 to an object; encoding the RFID cable identification device with data describing the object; inspecting the object; adding a first visual indicia to the RFID object identification device indicating that inspection has occurred at a predetermined time; leaving the object for a predetermined time; visually identifying an object for which inspection is due according to the first visual indicia; reading the RFID tag of the RFID object identification device; inspecting the object; and adding second visual indicia over the first visual, and at least partially obscuring the first visual indicia.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of an embodiment having a roughly cylindrical housing;

FIG. 2 is a perspective view of an embodiment having a rectangular housing;

FIG. 3 is a perspective view of an embodiment having a roughly cylindrical housing, wherein the housing is drawn semi-transparent;

FIG. 4 is a perspective view of an embodiment having a rectangular housing, wherein the housing is drawn semi-transparent; and

FIG. 5 is a drawing of an embodiment having a housing that includes a curved surface.

### IV. DETAILED DESCRIPTION OF THE INVENTION

As used herein the term RFID includes all radio frequency identification devices suitable for the devices and methods of the present invention. As used herein, the term “working cable” refers to cables that are used for tasks such as lifting or pulling heavy objects, wherein the cables bare identification tags and are subject to inspection. Working cables are distinct from structures referred to herein as loopable members although a loopable member can comprise a cable.

The present invention generally relates to devices and methods for identifying objects using RFID technology. Some embodiments relate to devices and methods for identifying working cables, quickly determining whether they are due for inspection and/or limiting waste resulting from inspection regimes. Some embodiments also include a housing member and a loopable member connectable to the housing member and adapted to form a closed loop. Furthermore, some embodiments include an RFID tag disposed within the housing and containing data identifying and/or describing a cable. Optionally, some embodiments can include a means for accepting colored tape for color coding. Additionally, some embodiments can optionally include a surface adapted to limit snagging of the embodiment.

According to one embodiment, the housing member can comprise any of a variety of suitable shapes. For instance some embodiments can comprise rectangular, spherical, or cylindrical shapes or any combination thereof. Some factors that may contribute to the suitability of a shape include, without limitation, amenability to stacking, ease of assembly, and amenability to scanning the RFID tag housed therein. Furthermore, a wide variety of materials can be suitable for constructing a housing. In general, suitable materials do not shield the RFID signal from an external scanner. Some suitable materials include, without limitation, organic polymers such as polyolefins, high-density polyolefins, phenolic polymers, nylon polymers, polyesters, polystyrenes, polycarbonates and the like and any combination thereof. Some embodiments can comprise polymers that are suitable for injection molding processes. Still other embodiments can comprise composite materials such as fiberglass/polymer composites and/or carbon fiber composites.

According to some embodiments a loopable member can comprise a braided metal cable, a fabric rope, a polymeric rope, or a non-braided polymeric cord. Some loopable members can include a sheath such as a polymeric sheath. Any of a wide variety of loopable members can be appropriate provided they are sufficiently strong and durable to function in environments where the objects and/or cables to which they attach are normally used.

According to some embodiments the housing member also includes one or more means for anchoring the loopable member to the housing. In some embodiments an anchoring means can comprise a screw, bolt, vice, weld joint, and/or braze joint. Further, according to some embodiments an anchoring means can comprise bonding the loopable member to the housing member, for instance, with a polymer resin, or by embedding a portion of the loopable member in the housing during a molding process. Still further, in some embodiments an anchoring means can comprise a one-way socket device, wherein the socket accepts an end of a loopable member when such end is inserted into the socket, and wherein the socket locks onto the loopable member when the loopable member is pulled away from the socket. Some embodiments can comprise any combination of any of the foregoing anchoring means.

The RFID tag can comprise any of a wide variety of known devices and off-the-shelf components. For instance, appropriate RFID tags can include active, passive and semi- passive tags. Some embodiments can comprise RFID tags that include integrated circuits, or RFID tags that do not include integrated circuits, i.e. chipless RFID. Furthermore, appropriate RFID tags can include one or more antennae that are inductively coupled, capacitively coupled and/or radiatively coupled. Suitable antennae can include, without limitation, one or more dipole or dual dipole antennae. Some embodiments can include RFID tags that have a preferred orientation for reading. For example, in some passive RFID tags the reader is preferably positioned relatively close to, and roughly perpendicular to, a face of the RFID tag where signals are more efficiently exchanged between the RFID tag and the reader. Still further, suitable RFID tags can include volatile and/or non-volatile memory components. Suitable memory components can comprise read-write and/or read-only components, such as EPROMs and/or EEPROMs.

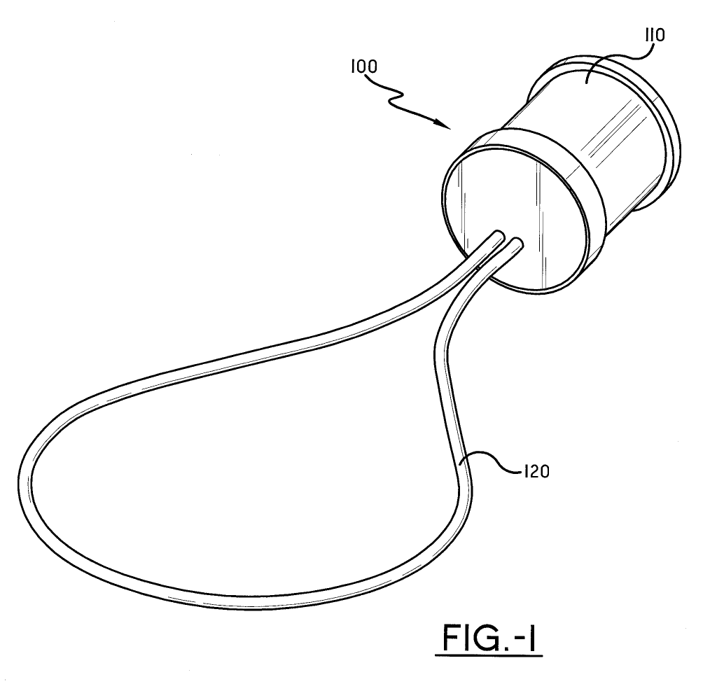

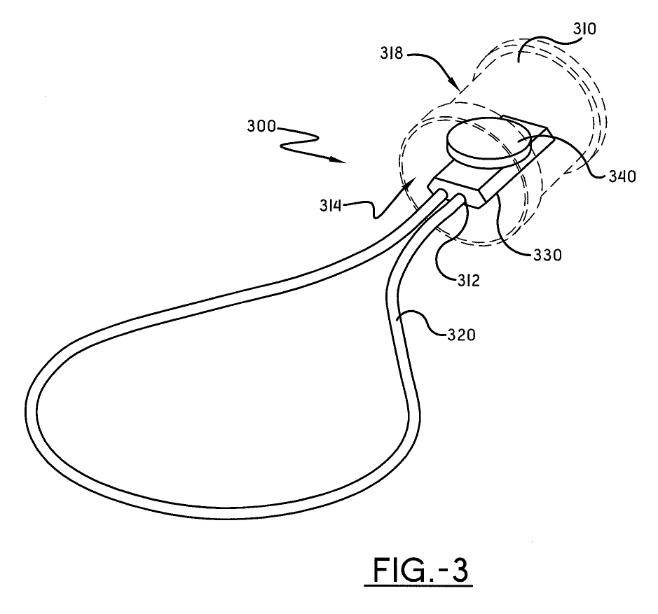

Referring now to the drawings wherein the showings are for purposes of illustrating embodiments of the invention only and not for purposes of limiting the same, FIG. 1 is a drawing of an embodiment 100 having a roughly cylindrical housing 10 and a loopable member 120 attached thereto at two points. FIG. 3 shows the same embodiment wherein the housing 310 is drawn semitransparent thereby revealing several internal components. In FIG. 3 the embodiment 300 is shown with a loopable member 320 penetrating the housing 310 at two points and attaching to an anchoring means 330. The anchoring means 330 comprises a one-way socket device, into which the loopable member 320 cannot be removed once inserted therein unless a release mechanism is triggered.

Further according to FIG. 3, an RFID tag 340 is also included. In this embodiment, the RFID tag 340 is generally circular in shape and one circular face is oriented approximately perpendicular to a recessed radial face 318 of the housing 310. In some embodiments, the RFID tag 340 can include a dual dipole antenna so that reading the RFID tag 340 therein is less dependant upon orientation of the reader relative to the RFID tag 340. In alternative embodiments, a circular face of the RFID tag 340 can be oriented perpendicular to the back face 316 of the housing 310. Thus, the optimal orientation of the reader relative to the RFID tag 340 is readily ascertainable, i.e. the reader should be aligned perpendicular to the back face 316 of the housing 310.

The embodiments shown in both FIGS. 1 and 3 include a recessed radial surface 118, 318 incorporated into the housing 110, 310. The recessed radial surface 118, 318 is adapted to receive, for example, colored tape or paint. Thus, the housing 110, 310 can be changeably color coded. Accordingly, an inspector can conduct a rapid visual search for housings baring a particular color code, which indicates that inspection is due. He can then read the RFID tag, inspect the object and/or working cable to which it is attached, and apply a new color code indicating that the scheduled inspection is complete.

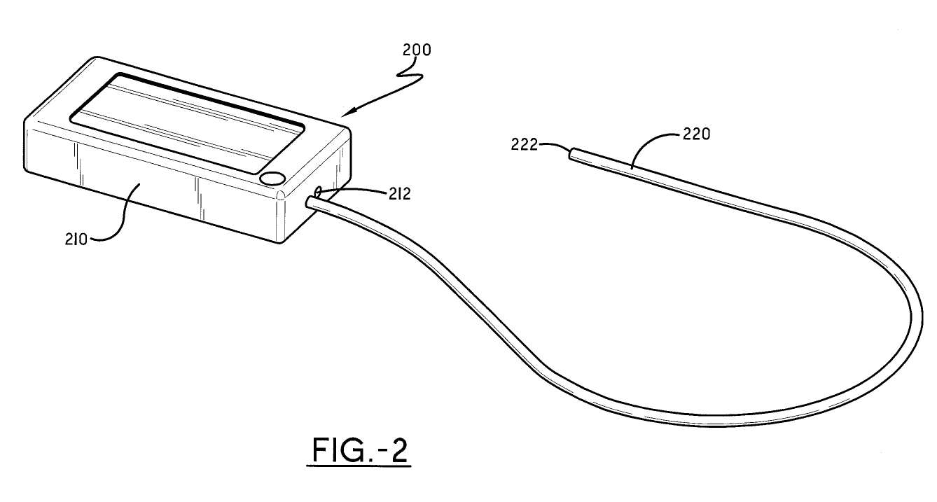

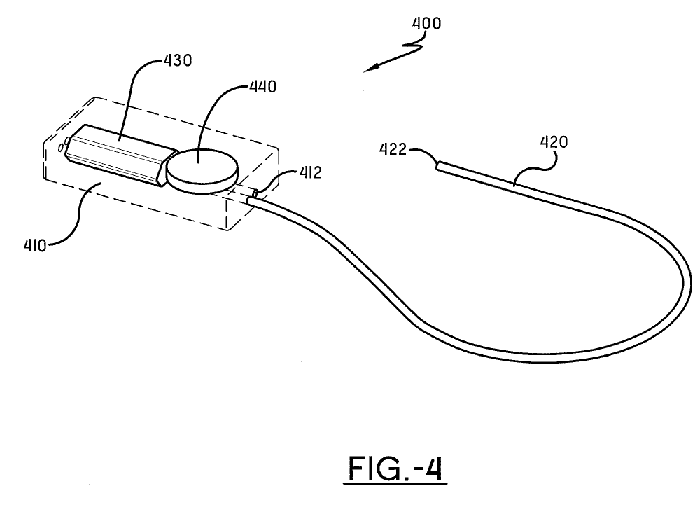

FIG. 2 shows an embodiment 200 having a generally rectangular housing 210. The housing 210 has a pair of holes 212 for accepting a loopable member such as a cable 220. The cable 220 has an end 222 that is insertable into the hole 212. The housing 210 also includes a recessed face 214 adapted to receive, for example, colored tape or paint for color coding similar to embodiments 100 and 300. FIG. 4 shows a similar embodiment 400, but the housing 410 is drawn semi-transparent. This embodiment 400 includes a loopable member 420 having an end 422 that is insertable into a hole 412. As shown, the hole 412 leads to an anchoring means 430 disposed within the housing 410. In this embodiment the anchoring means 430 comprises a one-way socket device, into which the loopable member 420 cannot be removed once inserted therein unless a release mechanism is triggered.

Further according to FIG. 4, an RFID tag 440 is also included. In this embodiment, the RFID tag 440 is generally circular in shape and one circular face is oriented approximately perpendicular to a face of the housing 410. In some embodiments, the RFID tag 440 can include a dual dipole antenna so that reading the RFID tag 440 therein is less dependant upon orientation of the reader relative to the RFID tag 440.

The embodiments shown in both FIGS. 2 and 4 include a recessed surface 214, 414 incorporated into the housing 210, 410. The recessed surface 214, 414 is adapted to receive, for example, colored tape or paint. Thus, the housing 210, 410 can be changeably color coded. Accordingly, similar to embodiments 100 and 300, an inspector can quickly identify objects and/or working cables for which inspection is due.

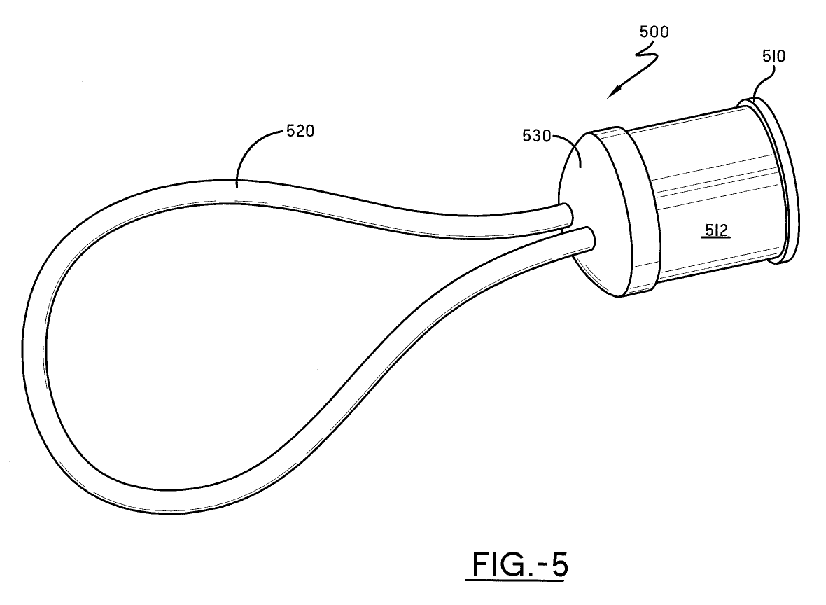

FIG. 5 shows an embodiment 500 having a curved surface 530 through which a loopable member 520 attaches. According to this embodiment 500 the housing 510 has a generally cylindrical shape, and a recessed radial surface 512 adapted to receive a color coding means such as colored tape. The curved surface 530 is functional to deflect impinging bodies, thereby diminishing, mitigating and/or eliminating the occurrence of snags. For example, while the working cable is in use, an embodiment may be impinged upon by a body. Further, when the impact is directed to the portion of the housing where the loopable member attaches the embodiment to the working cable, the impact will tend to pull the embodiment away from the working cable and may thereby damage the embodiment. However, if the embodiment includes a curved surface such as 530 in embodiment 500, then the impacting body will tend to slide off the housing 510.

Several illustrative embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

I/We Claim:

1. An object identification device, comprising:
a housing having at least one outer surface and at least one inner surface spaced apart from the outer surface and defining a thickness, the inner surface enclosing a space adapted to receive one or more components;
at least one RFID tag;
a loopable member having two ends spaced apart and defining a generally elongate shape; and
at least one anchor member for anchoring the ends of one or more ends of the loopable member in a fixed configuration relative to the housing.

2. The device of claim 1, wherein the at least one RFID tag is adapted to store identification and/or inspection data.

3. The device of claim 1, wherein the at least one RFID tag is selected from one or more of active, passive, or semipassive.

4. The device of claim 1, wherein the at least one RFID tag comprises a chipless RFID tag.

5. The device of claim 1, wherein the at least one RFID tag is in electronic communication with one or more antennae.

6. The device of claim 5, wherein the one or more antennae are selected from one or more of inductively coupled, capacitively coupled, or radiatively coupled.

7. The device of claim 1, wherein the at least one RFID tag is in electronic data communication with one or more memory components.

8. The device of claim 1, wherein the at least one RFID tag is attached to an inner surface of the housing

9. The device of claim 1, wherein the loopable member comprises a material selected from one or more of metal cable, rope, or non-braided polymeric cord.

10. The device of claim 9, wherein the loopable member further comprises an outer sheath encasing an inner loopable member.

11. The device of claim 1, wherein the anchor member comprises at least one one-way socket device adapted to accept an end of the loopable member in a gripping relation.

12. The device of claim 11, wherein the anchor member further comprises a release mechanism adapted to release the end of the loopable member from the gripping relation.

13. The device of claim 1, wherein the at least one anchor member is attached to an inner surface of the housing.

14. The device of claim 1, wherein the housing includes a curved surface adapted to deflect impinging bodies.

15. The device of claim 1, wherein the housing further comprises a recessed surface adapted to receive a color coding means.

16. The device of claim 15, wherein the color coding means comprises colored tape or colored paint.

17. The device of claim 1, wherein the object identification device is used for working cable inspection regimes.

18. A method for inspecting objects comprising the steps of:
attaching the object identification device of claim 1 to an object;
encoding the RFID cable identification device with data describing the object;
inspecting the object;
adding a first visual indicia to the RFID object identification device indicating that inspection has occurred at a predetermined time;
leaving the object for a predetermined time;
visually identifying an object for which inspection is due according to the first visual indicia;
reading the RFID tag of the RFID object identification device;
inspecting the object; and
adding second visual indicia over the first visual, and at least partially obscuring the first visual indicia.

19. The method of claim 18, wherein the object comprises a working cable.
